(19) United States
(12) Patent Application Publication
(10) Pub. No.: US 2022/0411593 A1
(43) Pub. Date: Dec. 29, 2022

(54) OPACIFIED POLYMERIC COMPOSITIONS

(71) Applicant: AMERICHEM, Cuyahoga Falls, OH (US)

(72) Inventor: Bhuvanesh C. Yerigeri, Copley, OH (US)

(21) Appl. No.: 17/780,797

(22) PCT Filed: Nov. 25, 2020
(86) PCT No.: PCT/US2020/062302

§ 371 Date: May 27, 2022

Related U.S. Application Data
(60) Provisional application No. 62/941,254, filed on Nov. 27, 2019.

(51) Int. Cl. C08J 3/22; C08K 3/04; B65D 81/30

(52) U.S. Cl. CPC C08J 3/22; C08K 3/04; B65D 81/30; C08K 2003/2265

(57) ABSTRACT

An opacified polymeric composition including a first polymer having a first refractive index; a second polymer having a second refractive index, wherein the second refractive index of the second polymer is lower than the first refractive index of the first polymer; a light scattering inorganic additive; a light absorbing additive; and a light reflecting additive.

### CROSS-REFERENCE TO RELATED APPLICATIONS

The present application claims benefits and priority to U.S. Provisional Patent Application No. 62/941,254, filed on Nov. 27, 2019, the entire disclosure of which is incorporated herein by reference.

### FIELD

The present disclosure relates to opacified polymeric compositions that include a light scattering inorganic additive, a light absorbing additive; and a light reflecting additive.

### BACKGROUND

During the journey from supplier to end user, packaged food products are exposed to a variety of light sources such as outdoor and indoor lighting conditions, fluorescent, LED, incandescent, etc. Exposure to light may reduce the quality of the food products by causing the food products to have off flavors and the degradation of vitamins such as riboflavin, vitamin B2, and D3. Accordingly, highly opaque packaging is desired to extend the shelf life of food products and reduce the occurrence of off flavors.

Molded plastic packaging is desirable due to the ability to prepare a variety of shapes and the ability to form lightweight packaging. However, some highly opaque plastic packages may be undesirable to consumers. For example, opacity may be improved with a high amount of dark colored pigments such as carbon black. A product with a black package may look less desirable on a shelf compared to a white or translucent package. Present solutions to preparing highly opaque plastic packing includes the use of very high levels of opacifiers or multilayered plastic packages. However, these solutions may make recycling of the products difficult.

### SUMMARY

In accordance with the present disclosure, a polymeric composition is provided, the polymeric composition comprising: a first polymer having a first refractive index; a second polymer having a second refractive index, wherein the second refractive index of the second polymer is lower than the first refractive index of the first polymer; a light scattering inorganic additive; a light absorbing additive; and a light reflecting additive.

In accordance with the present disclosure, a molded article is provided, the molded article comprising: an external wall that defines a hollow interior section; where the external wall comprises a polymer composition comprising: a first polymer having a first refractive index; a second polymer having a second refractive index, wherein the second refractive index of the second polymer is lower than the first refractive index of the first polymer; a light scattering inorganic additive; a light absorbing additive; and a light reflecting additive.

In accordance with the present disclosure, a method of preparing a blow-molded article is provided, the method comprising: (i) supplying a masterbatch comprising: a carrier polymer having a first refractive index, a light scattering inorganic additive, a light absorbing additive, and a light reflecting additive; (ii) mixing the masterbatch with a thermoplastic polymer having a second refractive index to form a polymeric composition, wherein the first refractive index of the carrier polymer is lower than the second refractive index of the thermoplastic polymer; and (iii) blowing air through the polymeric composition to form an article with an external wall that defines a hollow interior section.

### BRIEF DESCRIPTION OF THE DRAWINGS

FIG. 1 is a graph of percent transmission at wavelengths between 200 and 800 nm of polymer compositions that include a first polymer, a second polymer, a light scattering inorganic additive, and a light absorbing additive.

FIG. 2 is a graph of percent transmission at wavelengths between 200 and 800 nm of polymer compositions that include a first polymer, a second polymer, a light scattering inorganic additive, and a light reflecting additive.

FIG. 3 is a graph of percent transmission at wavelengths between 200 and 800 nm of polymer compositions that include a first polymer, a second polymer, a light scattering inorganic additive, a light absorbing additive, and a light reflecting additive.

Numerous other aspects, advantages, and/or features of the general inventive concepts will become more readily apparent from the following detailed description of exemplary embodiments, from the claims, and from the accompanying drawings being submitted herewith.

### DETAILED DESCRIPTION

While the general inventive concepts are susceptible of embodiment in many different forms, there are shown in the drawings, and will be described herein in detail, specific embodiments thereof with the understanding that the present disclosure is to be considered as an exemplification of the principles of the general inventive concepts. Accordingly, the general inventive concepts are not intended to be limited to the specific embodiments illustrated herein.

Unless otherwise defined, all technical and scientific terms used herein have the same meaning as commonly understood by one of ordinary skill in the art to which this invention belongs. The terminology used in the description is for describing particular embodiments only and is not intended to be limiting of the general inventive concepts. As used in the description and the appended claims, the singular forms “a,” “an,” and “the” are intended to include the plural forms as well, unless the context clearly indicates otherwise.

The present disclosure is directed, at least in part, to an opacified polymeric composition. The opacified polymeric composition includes a first polymer having a first refractive index, a second polymer having a second refractive index, wherein the second refractive index of the second polymer is different than the first refractive index of the first polymer, a light scattering inorganic additive, a light absorbing additive; and a light reflecting additive. As used herein, the light scattering inorganic additive, the light absorbing additive, and the light reflecting additive is collectively be referred herein to as “the additives.” The opacified polymeric composition provides advantageous levels of opacity with low levels of light scattering inorganic additives and/or at low thicknesses. Uses of the opacified polymeric composition disclosed herein include molded articles such as pharmaceutical, food, and beverage containers.

Without wishing to be bound by any particular theory, it is believed that when a first polymer includes a combination of the light scattering inorganic additive, the light absorbing additive, and the light reflecting additive along with the second polymer, the additives and the second polymer in combination with the first polymer produce a synergistically high opacity value. It is believed that the scattering effect of the light scattering inorganic additive increases the chance of light hitting a light absorbing additive thus being absorbed and/or hitting a light reflecting additive and get reflected back. The second polymer (or second polymer composition as described below) is not homogenously mixed into the opacified polymeric composition, and due to the difference in refractive index between the first polymer and the second polymer, the second polymer further increases light refraction by encapsulating the light scattering, light absorbing and/or the light reflecting additives, which provides additional opportunities for light to scatter in the opacified polymeric composition.

As indicated above, the opacified polymeric composition includes a first polymer. Suitable polymers for use as a first polymer include thermoplastic polymers. In accordance with the present disclosure, the first polymer may be characterized by a refractive index determined at a wavelength of visible light (i.e., 400 nm to 700 nm). In accordance with the present disclosure, the refractive index of the first polymer is greater than 1.51, greater than 1.53 and greater than 1.55. In accordance with the present disclosure, the refractive index of the first polymer is less than 1.75, less than 1.70, and less than 1.65. In accordance with the present disclosure, the refractive index of the first polymer is from about 1.51 to about 1.75, from about 1.53 to about 1.70, and from about 1.55 to about 1.65. Exemplary polymers that used as the first polymer include, but are not limited to polyesters, polyolefins, polyacrylates, polycarbonates, polyurethanes, polyamides, polyvinyl chloride (PVC), and combinations thereof. One skilled in the art will appreciate that the exemplary polymers are described with reference to repeating mer units or functional groups. Accordingly, certain polymers may include two or more of the repeating mer units or functional groups and overlap or fall into one or more of the different polymeric types.

Specific examples of suitable polyesters include, but are not limited to polyethylene terephthalate, polybutylene terephthalate, polytrimethylene terephthalate, polyethylene naphthalate, polylactic acid (PLA), polyhydroxyalkanoates (PHA), and combinations thereof.

Specific examples of suitable polyolefins include, but are not limited to polyethylene, polypropylene, high density polyethylene, copolymers of polyethylene and polypropylene, and combinations thereof.

Specific examples of suitable polyacrylates include, but are not limited to poly(methyl methacrylate) (PMMA), poly(ethyl methacrylate), poly(hydroxyl methacrylate), and combinations thereof.

Specific examples of suitable polycarbonates include, but are not limited to, those that include units derived from the polymerization of bisphenol A. Commercial examples of polycarbonates include, but are not limited to LEXAN, which is available from Sabic global technologies, and MAKROLON, which is available from Bayer Material Science.

In accordance with the present disclosure, the first polymer is characterized by the weight percent (wt %) of the first polymer based on the total weight of the opacified polymeric composition. In accordance with the present disclosure, the opacified polymeric composition includes at least 65 wt %, at least 85 wt %, at least 90 wt %, at least 92.5 wt %, and at least 95 wt % of the first polymer. In accordance with the present disclosure, the opacified polymeric composition includes at most 99 wt %, at most 98 wt %, at most 97.5 wt %, at most 97 wt %, and at most 96 wt % of the first polymer. In accordance with the present disclosure, the opacified polymeric composition includes the first polymer in the range of about 65 wt % to about 99 wt %, in the range of about 85 wt % to about 98 wt %, in the range of about 90 wt % to about 97.5 wt %, in the range of about 92.5 wt % to about 97 wt %, and in the range of about 95 wt % to about 96 wt %.

As indicated above, the opacified polymeric composition includes a second polymer. Suitable polymers for use as a second polymer include thermoplastic polymers with a refractive index that is different than the first refractive index of the first polymer. In accordance with the present disclosure, the first polymer and the second polymer in the opacified polymeric composition may have a difference in refractive index of at least 1%, at least 3%, at least 5%, at least 8%, and at least 10%. In accordance with the present disclosure, the first polymer and the second polymer in the opacified polymeric composition may have a difference in refractive index in the range of about 1% to about 15%, in the range of about 3% to about 14%, in the range of about 5% to about 13%, and in the range of about 8% to about 12%.

In accordance with the present disclosure, the second polymer may be characterized by a refractive index. In accordance with the present disclosure, the refractive index of the second polymer is less than 1.51 less than 1.48 and less than 1.47. In accordance with the present disclosure, the refractive index of the second polymer is greater than 1.30, greater than 1.35, and greater than 1.40. In accordance with the present disclosure, the refractive index of the second polymer is from about 1.30 to about 1.51, from about 1.35 to about 1.48, and from about 1.40 to about 1.47.

Exemplary polymers that may be used as the second polymer include, but are not limited to polymethylpentene (PMP), polydimethylsiloxane (PDMS), and fluoropolymers such as polytetrafluoroethylene, polyhexafluoropropylene oxide, fluorinated ethylene propylene, and combinations thereof.

In accordance with the present disclosure, the second polymer may be included in a secondary polymeric composition. In addition to the second polymer, the secondary polymeric composition may further comprise one or more polymers, which for the purpose of this disclosure may be referred to as co-second polymer(s). The co-second polymer(s) is different from the second polymer and have a refractive index lower than the refractive index of the first polymer. The second polymer and one or more co-second polymers may be mixed (for example, using conventional mixing methods) to prepare the secondary polymeric composition.

In accordance with the present disclosure, the co-second polymer may have a refractive index that is the same or different than that of the second polymer. In accordance with the present disclosure, the co-second polymer may have a refractive index that less than the second polymer or the co-second polymer may have a refractive index that less than the first polymer and greater than the second polymer. In accordance with the present disclosure, the secondary polymer composition may have a refractive index that is lower than the refractive index of the first polymer.

In accordance with the present disclosure, the co-second polymer may be characterized by a refractive index determined at a wavelength of visible light. In accordance with the present disclosure, the refractive index of the co-second polymer is greater than 1.30, greater than 1.35, and greater than 1.40. In accordance with the present disclosure, the refractive index of the co-second polymer is less than 1.70, less than 1.68, and less than 1.65. In accordance with the present disclosure, the refractive index of the co-second polymer is from about 1.30 to about 1.70, from about 1.35 to about 1.68, and from about 1.40 to about 1.65.

Suitable polymers for use as the co-second polymer include, but are not limited to polyethylene terephthalate (PET), polypropylene (PP), polycarbonate (PC), polymethyl methacrylate (PMMA), polymethylpentene (PMP), polydimethylsiloxane (PDMS), and fluoropolymers such as polytetrafluoroethylene, polyhexafluoropropylene oxide, fluorinated ethylene propylene, polymethyl methacrylate, polycarbonate, polyethylene oxide, and combinations thereof.

In accordance with the present disclosure, the second polymer or secondary polymer composition may be characterized by the weight percent (wt %) of the second polymer or secondary polymer composition based on the total weight of the opacified polymeric composition. In accordance with the present disclosure, the opacified polymeric composition includes at least 0.5 wt %, at least 1 wt %, and at least 2 wt % of the second polymer or secondary polymer composition. In accordance with the present disclosure, the opacified polymeric composition includes at most 6 wt %, at most 5 wt %, and at most 4 wt % of the second polymer or secondary polymer composition. In accordance with the present disclosure, the opacified polymeric composition includes the second polymer or secondary polymer composition in the range of about 0.5 wt % to about 6 wt %, in the range of about 1 wt % to about 5 wt %, and in the range of about 2 wt % to about 4 wt %.

In accordance with the present disclosure, when a secondary polymer composition is employed in the opacified polymeric composition, the secondary polymeric composition may be characterized by the weight percent (wt %) of the second polymer based on the total weight of the secondary polymeric composition (i.e., the mass of the total amount of the second polymer and one or more co-second polymers). In accordance with the present disclosure, the secondary polymeric composition includes at least 30 wt %, at least 35 wt %, 40 wt %, and at least 45 wt % of the second polymer. In accordance with the present disclosure, the secondary polymeric composition includes at most 70 wt %, at most 65 wt %, at most 60 wt %, and at most 55 wt % of the second polymer. In accordance with the present disclosure, the secondary polymeric composition includes the second polymer in the range of about 30 wt % to about 70 wt %, in the range of about 35 wt % to about 65 wt %, in the range of about 40 wt % to about 60 wt %, and in the range of about 45 wt % to about 55 wt %.

In accordance with the present disclosure, the secondary polymer composition may be characterized by a refractive index. In accordance with the present disclosure, the refractive index of the secondary polymer composition may be lower than the refractive index of the first polymer. In accordance with the present disclosure, the refractive index of the secondary polymer composition is less than 1.51 less than 1.48 and less than 1.47. In accordance with the present disclosure, the refractive index of the secondary polymer composition is greater than 1.30, greater than 1.35, and greater than 1.40. In accordance with the present disclosure, the refractive index of the secondary polymer composition is from about 1.30 to about 1.51, from about 1.35 to about 1.48, and from about 1.40 to about 1.47.

As indicated above, the opacified polymeric composition includes a light scattering inorganic additive. Light scattering inorganic additives function to scatter light within the opacified polymeric composition by having a different refractive index than the first polymer (and optionally the second polymer or secondary polymeric composition). Accordingly, when incident light enters the opacified polymeric composition it refracts and scatters when it reaches a light scattering inorganic additive. As indicated above, the light scattering inorganic additive may be encapsulated by the second polymer or secondary polymeric composition with the second refractive index and suspended within the first polymer with the first refractive index. In the present disclosure, the opacified polymeric composition may include a first polymer having a first refractive index, a second polymer or secondary polymeric composition having a second refractive index, and a light scattering inorganic additive having a third refractive index, wherein the first refractive index of the first polymer is higher than the second refractive index of the second polymer or secondary polymeric composition and the third index of the light scattering inorganic additive is higher than the first refractive index of the first polymer. In the present disclosure, the opacified polymeric composition may include a first polymer having a first refractive index, a second polymer or secondary polymeric composition having a second refractive index, and a light scattering inorganic additive having a third refractive index, wherein the second refractive index of the second polymer or secondary polymeric composition is higher than the first refractive index of the first polymer and the third index of the light scattering inorganic additive is higher than the second refractive index of the second polymer or secondary polymeric composition.

Exemplary light scattering inorganic additives include, but are not limited TiO₂, CaCO₃, ZnO, BaSO₄, silica, talc, ZnS, SB₂O₃, BaS, and combinations thereof.

Specific examples of titanium dioxide include rutile titanium dioxide and anatase titanium dioxide. Those skilled in the art will appreciate that titanium dioxide may be prepared by what is referred to as the chloride process or the sulfate process.

In one or more embodiments, the light scattering inorganic additive may be in the form of a particle. In one or more embodiments, the light scattering inorganic additive may be characterized by a median particles size, which may be determined by laser diffraction. In one or more embodiments, the median particles size of the light scattering inorganic additive is greater than 0.2 microns, in other embodiments greater than 0.3 microns, in other embodiments greater than 0.4 microns, in other embodiments greater than 0.5 microns, and in other embodiments greater than 1 micron. In one or more embodiments, the median particles size of the light scattering inorganic additive is less than 45 microns, in other embodiments less than 30 microns, in other embodiments less than 15 microns, in other embodiments less than 10 microns, and in other embodiments less than 5 microns. In one or more embodiments, the median particles size of the light scattering inorganic additive is from about 0.2 microns to about 45 microns, in other embodiments from about 0.3 microns to about 30 microns, in other embodiments from about 0.4 microns to about 15 microns, in other embodiments from about 0.5 microns to about 10 microns, and in other embodiments from about 1 micron to about 5 microns.

In the present disclosure, the light scattering inorganic additive may be characterized by a refractive index. In accordance with the present disclosure, the refractive index of the light scattering inorganic additive is greater than 1.5, greater than 1.75, and greater than 2. In accordance with the present disclosure, the refractive index of the light scattering inorganic additive is less than 3.5, less than 3 and less than 2.75. In accordance with the present disclosure, the refractive index of the light scattering inorganic additive is from about 1.5 to about 3.5, from about 2 to about 3, and from about 2 to about 2.75.

In the present disclosure, the opacified polymeric composition may be characterized by the weight percent (wt %) of the light scattering inorganic additive based on the total weight of the opacified polymeric composition. In accordance with the present disclosure, the opacified polymeric composition includes at least 0.5 wt %, at least 0.6 wt %, at least 0.8 wt %, at least 1 wt %, and at least 1.2 wt % of the light scattering inorganic additive. In accordance with the present disclosure, the opacified polymeric composition includes at most 4 wt %, at most 3.5 wt %, at most 3 wt %, at most 2.5 wt %, and at most 2 wt % of the light scattering inorganic additive. In accordance with the present disclosure, the opacified polymeric composition includes the light scattering inorganic additive in the range of about 0.5 wt % to about 4 wt %, in the range of about 0.6 wt % to about 3.5 wt %, in the range of about 0.8 wt % to about 3 wt %, in the range of about 1 wt % to about 2.5 wt %, and in the range of about 1.2 wt % to about 2 wt %.

As indicated above, the opacified polymeric composition includes a light absorbing additive. Light absorbing additives are pigments that function to absorb light within the opacified polymeric composition by absorbing wavelengths of light within the visible spectrum that hits the additive. In the present disclosure, the light absorbing additive may absorb all of the wavelengths that are present in visible light and/or absorb only a portion of the wavelengths that are present in visible light and reflect a portion of the wavelengths that are present in visible light. In one or more embodiments, both a light absorbing additive absorbs all of the wavelengths that are present in visible light and a light absorbing additive only absorbs a portion of the wavelengths that are present in visible light and reflects a portion of the wavelengths that are present in visible light may be employed.

Light absorbing additives that absorb all or substantially all of the visible spectrum wavelengths that are present in visible light may be referred to as black pigments. Exemplary black pigments include, but are not limited to carbon black, iron oxide black (which may also be referred to as ferric oxide), chrome iron oxide, nickel iron chrome, copper chrome, and combinations thereof. Specific examples of carbon black include acetylene black, channel black, furnace black, lamp black, and thermal black.

Light absorbing organic additives that only absorb a portion of the wavelengths that are present in visible light may be referred to as colored pigments. Light absorbing inorganic additives that only absorb a portion of the wavelengths and reflect or scatter the other portions of the visible light may be referred to as colored pigments. Exemplary color pigments include, but are not limited to metal oxides, metal sulfates metal sulfides, Mixed metal salts, Complex inorganic metal mixtures, Ultramarines and combinations thereof. Exemplary color pigments include, but are not limited to, anthroquinones, benzimidazalone, naphtonic acid, napthol pigments dizaos, diketo pyrrolo pyrrole, dioxazine, isoindolinone, mono azo salts, naphtol lake, pthalo, quinacridone, thio indigo, flavothrone, nitro, quinone, indgoid, triaryl carbonium, quinophathalone, and combinations thereof.

In the present disclosure, the light absorbing additive may be in the form of a particle. In accordance with the present disclosure, the light absorbing additive may be characterized by an average primary particles size, which may be determined by laser diffraction. In accordance with the present disclosure, the average primary particles size of the light absorbing additive is greater than 10 nm, greater than 25 nm, and greater than 50 nm. In accordance with the present disclosure, the average primary particles size of the light absorbing additive is less than 300 nm, less than 250 nm, and less than 200 nm. In accordance with the present disclosure, the average primary particles size of the light absorbing additive is from about 10 nm to about 300 nm, from about 25 nm to about 250 nm, and from about 50 nm to about 200 nm.

In the present disclosure, the light absorbing additive may be characterized by the weight fraction (in parts per million ‘ppm’) of the second polymer based on the total weight of the opacified polymeric composition. In accordance with the present disclosure, the opacified polymeric composition includes at least 50 ppm, at least 100 ppm, and at least 200 ppm of the light absorbing additive. In accordance with the present disclosure, the opacified polymeric composition includes at most 15,000 ppm at most 11,000 ppm, and at most 5,000 ppm of the light absorbing additive. In accordance with the present disclosure, the opacified polymeric composition includes the light absorbing additive in the range of about 50 ppm to about 15,000 ppm, in the range of about 100 ppm to about 11,000 ppm, and in the range of about 200 ppm to about 5,000 ppm.

As indicated above, the opacified polymeric composition includes a light reflecting additive. Light reflecting additives function to reflect incident light within the opacified polymeric composition that hits the additive. In the present disclosure, the light reflecting additive may be in the form of a flake.

Exemplary light reflecting additive include, but are not limited to, metal flakes special effect pigment or pearlescent, fluorescent, metallic, and combinations thereof.

Specific examples of metal flakes include, but are not limited to, aluminum flakes.

In accordance with the present disclosure, the light reflecting additive may be characterized by a median diameter. In accordance with the present disclosure, the median diameter of the light reflecting additive is greater than 5 microns, greater than 5.5 microns, and greater than 6 microns. In accordance with the present disclosure, the median diameter of the light reflecting additive is less than 30 microns, less than 15 microns, and less than 10 microns. In accordance with the present disclosure, the median diameter of the light reflecting additive is from about 5 microns to about 30 microns, from about 5.5 microns to about 15 microns, and from about 6 microns to about 10 microns.

In accordance with the present disclosure, the light reflecting additive may be characterized by the weight fraction (in parts per million) based on the total weight of the opacified polymeric composition. In accordance with the present disclosure, the opacified polymeric composition includes at least 1 ppm, at least 25 ppm, and at least 50 ppm of the light reflecting additive. In accordance with the present disclosure, the opacified polymeric composition includes at most 1,000 ppm, at most 750 ppm, and at most 500 ppm of the light reflecting additive. In accordance with the present disclosure, the opacified polymeric composition includes the light reflecting additive in the range of about 1 ppm to about 1,000 ppm, in the range of about 25 ppm to about 750 ppm, and in the range of about 50 ppm to about 500 ppm.

In accordance with the present disclosure, the opacified polymeric composition may include one or more optional components. Optional components may include processing aids such as waxes, release agents, etc.

In accordance with the present disclosure, the opacified polymeric composition may be characterized by the total weight percent (wt %) of the light scattering inorganic additive, the light absorbing additive, and the light reflecting additive second polymer based on the total weight of the opacified polymeric composition. In accordance with the present disclosure, the opacified polymeric composition includes at least 0.5 wt %, at least 0.6 wt %, at least 0.7 wt %, at least 0.8 wt %, at least 0.9 wt %, at least 1 wt %, and at least 1.2 wt % of the total amount of the additives. In accordance with the present disclosure, the opacified polymeric composition includes at most 10 wt %, at most 4 wt %, at most 3.75 wt %, at most 3.5 wt %, at most 3.25 wt %, at most 3 wt %, at most 2.5 wt %, and at most 2 wt % of the total amount of the additives. In accordance with the present disclosure, the opacified polymeric composition includes the total amount of the additives in the range of about 0.5 wt % to about 4 wt %, in the range of about 0.6 wt % to about 3.75 wt %, %, in the range of about 0.7 wt % to about 3.5 wt %, %, in the range of about 0.8 wt % to about 3.25 wt %, in the range of about 0.9 wt % to about 3 wt %, in the range of about 1 wt % to about 2.5 wt %, and in the range of about 1.2 wt % to about 2 wt %.

The opacified polymeric composition may be prepared by convention polymer mixing methods. In accordance with the present disclosure, the opacified polymeric composition may be prepared by using a masterbatch. In accordance with the present disclosure, a masterbatch composition is prepared that includes the additives mixed into the second polymer, which may also be referred to as the carrier polymer. Optionally, if a secondary polymeric composition is employed, the second polymer may be mixed with a co-second polymers to form the secondary polymeric composition. The masterbatch composition that employs a secondary polymeric composition is prepared that includes the additives mixed into the secondary polymeric composition, which may also be referred to as the carrier polymer. The masterbatch is then mixed into the first polymer.

In accordance with the present disclosure, the masterbatch may include the carrier polymer (i.e., the second polymer or secondary polymeric composition), the light scattering inorganic additive, the light absorbing additive, and the light reflecting additive. In accordance with the present disclosure, the weight ratio of the carrier polymer, to the light scattering inorganic additive, to the light absorbing additive, to the light reflecting additive may be 0.05-95:0.05-90:0.05-35:0.01-2.5, 5-90:5-85:0.1-20:0.1-2, and 10-80:10-80:1-100:0.5-1.

In accordance with the present disclosure, each of the light scattering inorganic additive, the light absorbing additive, and the light reflecting additive may be at least partly encapsulated in the second polymer or secondary polymeric composition. The additives may be fully encapsulated or partially encapsulated in the second polymer or secondary polymeric composition by first preparing a masterbatch or otherwise mixing the additive into the second polymer or secondary polymeric composition before inclusion into the first polymer. Accordingly, a coating of the second polymer or secondary polymeric composition is formed that at least partially encapsulates the additives. Without wishing to be bound by any particular theory, it is believed that when the additives are at least partially encapsulated in the second polymer or secondary polymeric composition, light is further refracted prior to any interaction with the additives.

Regardless of how the opacified polymeric composition is prepared, a molded article may be prepared from the opacified polymeric composition. Suitable methods for preparing molded articles from the opacified polymeric composition include, but are not limited to, injection molding, blow molding, extrusion molding, compression molding, and rotomolding.

Without wishing to limit the practice of the disclosed opacified polymeric composition, the present disclosure will focus on the preparation of molded articles using blow molding. Although, those skilled in the art would be able to prepare molding articles using other molding methods. In a blow molding process, air is blown through the molten polymeric composition to form an article with an external wall that defines a hollow interior section. Suitable methods for preparing a blow-molded article may be prepared from the opacified polymeric composition include extrusion blow molding, injection blow molding, or injection stretch blow molding.

In accordance with the present disclosure, the blow molding process includes forming the opacified polymeric composition into a parison or a preform. The parison or a preform is placed into a mold and air is blown into the parison or a preform. The pressure from the air pushes the opacified polymeric composition to shape that conforms to the surface of the mold. Accordingly, an article is form with a hollow interior and an external wall is formed. The opacified polymeric composition is allowed to cool or partial cool and is released from the mold.

In accordance with the present disclosure, the opacified polymeric composition may be used to prepare an article, such as a container. The container may include an external wall that comprises the opacified polymeric composition that defines a hollow interior section. In the present disclosure, the external wall may be a single layer wall that comprises the opacified polymeric composition. In the present disclosure, the external wall may be a multilayer structure that includes a layer of that comprises the opacified polymeric composition and/or more layers that comprise the opacified polymeric composition or a different polymeric composition. In accordance with the present disclosure, the external wall may be characterized by an average thickness. In one or more embodiments, the average thickness of the external wall has a thickness in the range of about 100 microns to about 400 microns, in the range of about 175 microns to about 350 microns, and in the range of about 200 microns to about 300 microns.

In the present disclosure, the opacified polymeric composition may be characterized by the change in pressure over time, which may be determined by a pressure filter or ΔP test. Those skilled in the art will appreciate that the pressure filter value or ΔP may provide insights into the processability of a polymer composition and the degree of additive dispersion. In accordance with the present disclosure, the opacified polymeric composition exhibits a maximum ΔP of 2 bar/gram, 1.5 bar/gram, or 1 bar/gram.

In the present disclosure, the opacified polymeric composition may be characterized by a percent light transmittance, which may be determined using a spectrophotometer. In accordance with the present disclosure, where the polymeric composition has a thickness of 200 microns, the percent transmittance at 700 nm of the opacified polymeric composition is less than 5%, less than 4%, less than 3%, less than 2%, less than 1%, less than 0.5%, less than 0.4%, less than 0.3%, and less than 0.2%.

In accordance with the present disclosure, the opacified polymeric composition may be a white opacified polymeric composition. The degree of whiteness may be determined using a colorimeter and characterized using the CIELAB color space (which may also be referred to as L*a*b*). In accordance with the present disclosure, opacified polymeric composition has an L value of at least 75, at least 78, at least 80, at least 85, at least 90, at least 91, at least 92, at least 93, at least 94, and at least 95.

Suitable articles that may be prepared from the opacified polymeric composition include storage articles such as bottles, containers, films, and molded articles. Due to the advantageous opacity of the opacified polymeric composition, the opacified polymeric composition is used with storage articles that help to control light degradation. The storage articles include those suitable for the storage of food, beverages, or pharmaceuticals. Suitable foods or beverages that may be stored include, but are not limited to, milk and milk-based beverages, fruit juices, chocolate drinks.

### EXAMPLES

Masterbatch containing various amounts of TiO2 (TiPure 103), Carbon Blacks (Lampblack 101, Arosperse 138) and Aluminum flakes (Silvet 210-30-E1) were dry blended in a polymer with a different refractive index than PET. In this case, examples of polymers are polymethylpentene (Mitsui TPX D845, Poly(dimethyl siloxane)/PET 50:50 Blend—Silaplast ES9722 from Excista or regular PDMS from Dow Silicones (Dowsil 1418).

Masterbatch making—Masterbatch was made by dry blending all the additives with the polymer and extruding on a 26 mm twin-screw extruder, tsa Industriale s.a.s. The masterbatch was then used at addition rates of 7% or higher into PET resin to blow bottles of 10 mil (254 microns) thick walls using a Nissei Injection Blow Molder.

The bottles so made were checked for percent transmission using a PerkinElmer UV/VIS/NIR spectrophotometer, Lambda 950 at wavelengths from 200 to 800 nm. The color was tested using an X-Rite color i7 to check for CIELab color using a D65 illuminant.

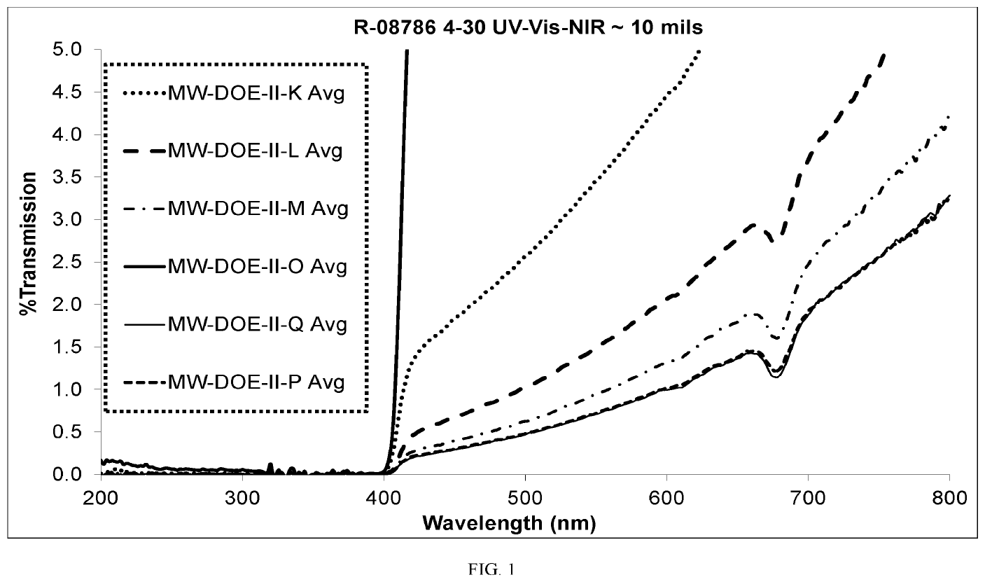

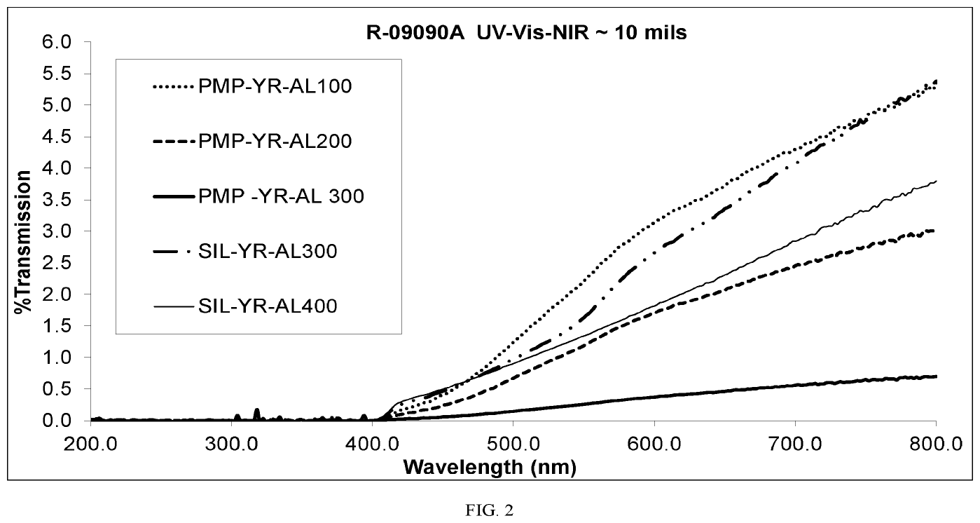

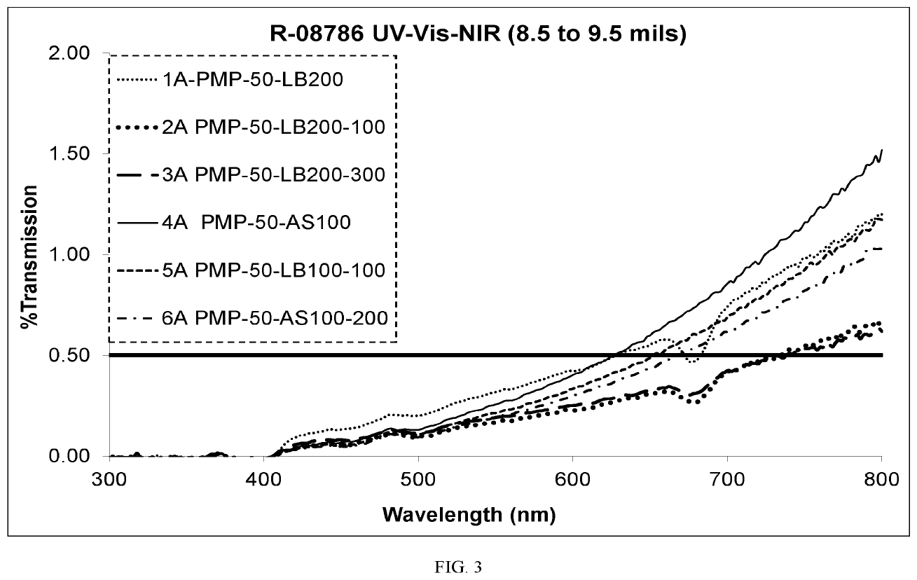

Formulas for bottle making and the results are shown in Tables 1-3. Graphs showing percent transmission at wavelengths between 200 and 800 nm for the samples of Tables 1, 2, and 3 are shown in FIGS. 1, 2, and 3, respectively.

TABLE 1
Effects of TiO₂ and Carbon Black on Opacity

| Formulation | MW-O | MW-K | MW-L | MW-M | MW-P | MW-Q |
|---|---|---|---|---|---|---|
| TiO₂ | 4% | 4% | 4% | 4% | 4% | 4% |
| Carbon Black | | 120 ppm | 160 ppm | 200 ppm | 250 ppm | 300 ppm |
| T % at 550 nm | 11.80% | 3.46% | 1.50% | 0.95% | 0.72% | 0.71% |
| T % at 700 nm | 18.41% | 7.07% | 3.70% | 2.47% | 1.92% | 1.87% |

TABLE 2
Effects of TiO₂ and Aluminum flakes on Opacity and Percent Transmission

| | | | | | | | | |
|---|---|---|---|---|---|---|---|---|
| TiO₂ | 4% | 4% | 4% | 4% | 4% | 4% | 4% | 4% |
| Low Ref | | PMP 4% | PMP 4% | PMP 4% | PMP 4% | PDMS 4% | PDMS 1.67% | PDMS 1.67% |
| Index | | | | | | | | |
| Polymer | | | | | | | | |
| Al flakes | | | 100 ppm | 200 ppm | 300 ppm | | 300 ppm | 400 ppm |
| T % at 550 nm | 11.80% | 3.21% | 2.21% | 1.18% | 0.25% | 4.11% | 1.63 | 1.34 |
| T % at 700 nm | 18.41% | 5.19% | 4.30% | 2.45% | 0.56% | 7.61% | 4.08 | 2.84 |

TABLE 3
Effects of TiO₂, Carbon Black, Aluminum flakes, on Opacity and Percent Transmission

| | 1A-PMP-50- | 2A-PMP-50- | 3A-PMP-50- | 4A-PMP-50- | 5A-PMP-50- | 6A-PMP-50- |
|---|---|---|---|---|---|---|
| Formulation % | LB200 | LB200-100 | LB200- 300 | AS100 | AS100-100 | AS100-200 |
| TiO2 | 4% | 4% | 4% | 4% | 4% | 4% |
| PMP | 4% | 4% | 4% | 4% | 4% | 4% |
| Lampblack 101 | 0.0200% | 0.0200% | 0.0200% | | | |
| Arosperse F 138 | | | | 0.0100% | 0.0100% | 0.0100% |
| Silvet 210-30-E1 | | 0.0100% | 0.0300% | | 0.0100% | 0.0200% |
| PET | 91.08% | 91.07% | 91.05% | 91.09% | 91.02% | 91.03% |
| L* | 82.22 | 81.08 | 79.88 | 79.31 | 78.78 | 78.22 |
| a* | −1.26 | −1.35 | −1.33 | −0.70 | −0.68 | −0.91 |
| b* | −3.06 | −3.46 | −3.65 | −1.89 | −1.89 | −2.46 |
| T % at 550 nm | 0.32% | 0.17% | 0.19% | 0.26% | 0.21% | 0.19% |
| T % at 700 nm | 0.74% | 0.42% | 0.42% | 0.86% | 0.69% | 0.61% |

The scope of the general inventive concepts are not intended to be limited to the particular exemplary embodiments shown and described herein. From the disclosure given, those skilled in the art will not only understand the general inventive concepts and their attendant advantages, but will also find apparent various changes and modifications to the methods and systems disclosed. It is sought, therefore, to cover all such changes and modifications as fall within the spirit and scope of the general inventive concepts, as described and claimed herein, and any equivalents thereof.

What is claimed is:

1. A polymeric composition comprising:
a first polymer having a first refractive index;
a second polymer having a second refractive index, wherein the second refractive index of the second polymer is lower than the first refractive index of the first polymer;
a light scattering inorganic additive;
a light absorbing additive; and
a light reflecting additive.

2. The polymeric composition of claim 1, where the weight percent of the sum of the light scattering inorganic additive, the light absorbing additive, and the light reflecting additive based on the total weight of the polymeric composition is less than 4 wt %.

3. The polymeric composition of claim 1, where
the second polymer has an amount in the range of 0.5 wt % to about 6 wt % based on the total weight of the polymeric composition;
the light scattering inorganic additive has an amount in the range of about 0.5 wt % to about 4 wt % based on the total weight of the polymeric composition;
the light absorbing additive has an amount in the range of about 50 ppm to about 15,000 ppm based on the total weight of the polymeric composition; and
the light reflecting additive has an amount in the range of about 1 ppm to about 1,000 ppm based on the total weight of the polymeric composition.

4. The polymeric composition of claim 1, where the second polymer is included in a secondary polymeric composition that includes one or more co-second polymers that have a refractive index that is lower than the first refractive index of the first polymer.

5. The polymeric composition of claim 4, where
the secondary polymeric composition has an amount in the range of 0.5 wt % to about 6 wt % based on the total weight of the polymeric composition;
the light scattering inorganic additive has an amount in the range of about 0.5 wt % to about 4 wt % based on the total weight of the polymeric composition;
the light absorbing additive has an amount in the range of about 50 ppm to about 15,000 ppm based on the total weight of the polymeric composition; and
the light reflecting additive has an amount in the range of about 1 ppm to about 1,000 ppm based on the total weight of the polymeric composition.

6. The polymeric composition of claim 1, where the first polymer is selected from the group consisting of polyesters, polyolefins, polyacrylates, polycarbonates, and combinations thereof.

7. The polymeric composition of claim 1, where the second polymer is selected from the group consisting of polymethylpentene (PMP), polytetrafluoroethylene, polydimethylsiloxane (PDMS), and combinations thereof.

8. The polymeric composition of claim 1, where the light scattering inorganic additive is selected from the group consisting of TiO₂, CaCO₃, ZnO, BaSO₄, silica, talc, and combinations thereof.

9. The polymeric composition of claim 1, where the light absorbing additive is selected from the group consisting of carbon black, iron oxide black, and combinations thereof.

10. The polymeric composition of claim 1, where the light reflecting additive is selected from the group consisting of metal flakes, special effect pigments, pearlescent pigments, and combinations thereof.

11. The polymeric composition of claim 1, where the co-second polymer is selected from the group consisting of polyethylene terephthalate (PET), polypropylene (PP), polycarbonate (PC), polymethyl methacrylate (PMMA), polymethylpentene (PMP), polydimethylsiloxane (PDMS), and fluoropolymers such as polytetrafluoroethylene, polyhexafluoropropylene oxide, fluorinated ethylene propylene, polymethyl methacrylate, polycarbonate, polyethylene oxide, and combinations thereof.

12. The polymeric composition of claim 1, where the light scattering inorganic additive has a median particle size in the range of 0.2 microns to about 45 microns.

13. The polymeric composition of claim 1, where the light scattering inorganic additive has a median particle size in the range of 0.2 microns to about 0.5 microns.

14. The polymeric composition of claim 1, where the light scattering inorganic additive, the light absorbing additive, and the light reflecting additive are at least partially encapsulated by the second polymer.

15. The polymeric composition of claim 1, wherein when the polymeric composition has a thickness of 200 microns, the polymeric composition has a percent transmittance of less than 0.5% at 700 nm.

16. A molded article comprising:
an external wall that defines a hollow interior section;
where the external wall comprises a polymer composition comprising:
a first polymer having a first refractive index;
a second polymer having a second refractive index, wherein the second refractive index of the second polymer is lower than the first refractive index of the first polymer;
a light scattering inorganic additive;
a light absorbing additive; and
a light reflecting additive.

17. The molded article of claim 16, where the weight percent of the sum of the light scattering inorganic additive, the light absorbing additive, and the light reflecting additive based on the total weight of the polymeric composition is less than 4 wt %.

18. The molded article of claim 16, where
the second polymer has an amount in the range of 0.5 wt % to about 6 wt % based on the total weight of the polymeric composition;
the light scattering inorganic additive has an amount in the range of about 0.5 wt % to about 4 wt % based on the total weight of the polymeric composition;
the light absorbing additive has an amount in the range of about 50 ppm to about 15,000 ppm based on the total weight of the polymeric composition; and
the light reflecting additive has an amount in the range of about 1 ppm to about 1,000 ppm based on the total weight of the polymeric composition.

19. The molded article of claim 16, where the external wall is a single layer wall.

20. The molded article of claim 16, wherein when the external wall has an average wall thickness of 200 microns, the external wall has a percent transmittance of less than 0.5% at 700 nm.

21. The molded article of claim 16, where the external wall has an average thickness in the range of about 100 microns to about 400 microns.

22. The molded article of claim 16, where the second polymer is included in a secondary polymeric composition that includes one or more co-second polymers that have a refractive index that is lower than the first refractive index of the first polymer.

23. A method of preparing a blow-molded article comprising:
(i) supplying a masterbatch comprising:
a carrier polymer having a first refractive index,
a light scattering inorganic additive,
a light absorbing additive, and
a light reflecting additive;
(ii) mixing the masterbatch with a thermoplastic polymer having a second refractive index to form a polymeric composition, wherein the first refractive index of the carrier polymer is lower than the second refractive index of the thermoplastic polymer; and
(iii) blowing air through the polymeric composition to form an article with an external wall that defines a hollow interior section.

24. The method of preparing a blow-molded article of claim 23, where the carrier includes a second polymer and a co-second polymer, where the refractive index of the second polymer is lower than the refractive index of the thermoplastic polymer and the refractive index of the co-second polymer is lower than the refractive index of the thermoplastic polymer.
